(19) United States
(12) Patent Application Publication
(10) Pub. No.: US 2006/0107599 A1
(43) Pub. Date: May 25, 2006

(54) Flush-mounted slider window for pick-up truck with hydrophilic coating on interior surface thereof, and method of making same

(75) Inventor: Henry A. Luten, Ypsilanti, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 10/996,046

(22) Filed: Nov. 24, 2004

(51) Int. Cl. E05D 15/06

(52) U.S. Cl. 49/413

(57) ABSTRACT

A window structure is provided which may be used as a rear window in a pick-up truck or the like. In certain example embodiments, the window structure includes a slidable window panel or sheet located between a pair of fixed window panels or sheets. The slidable window panel may have a hydrophilic coating on an interior major surface thereof for anti-fogging purposes.

This application is related to U.S. patent application Ser. Nos. 10/653,412, filed Sep. 3, 2003, Ser. No. 10/804,202, filed Mar. 19, 2004, and Ser. No. 10/967,342, filed Oct. 19, 2004, the entire disclosures of which are hereby incorporated herein by reference.

This invention relates to a slidable window which may be used as a rear window in a pick-up truck, heavy truck sleeper applications, or in any other suitable application. In certain example embodiments of this invention, a hydrophilic coating is provided on the interior surface of the slidable window. Certain example embodiments of this invention relate to a substantially flush-mounted slidable window for use as a rear window in a pick-up truck, wherein the window includes a pair of fixed window sheets and a slidable window sheet provided therebetween.

### BACKGROUND OF THE INVENTION

Rear windows for pick-up trucks, which have a slidable window sheet, are known in the art. For example, see U.S. Pat. Nos. 5,542,214, 5,996,284, 5,522,191, 4,124,054, and the like. However, the windows of the aforesaid patents each have their respective problems.

In slider window systems for pick-up trucks (e.g., see patents mentioned above), a center slidable window is typically provided between a pair of fixed windows. Each of the windows is typically made of glass. These windows are susceptible to fogging up in certain environmental conditions, especially the interior surface thereof. Unfortunately, conventional anti-fog systems such as a grid of conductors with a pair of corresponding bus bars cannot be practically located on the center window because of its sliding nature. In particular, the sliding movement of the center window prohibits the provision of electrical connectors on that window, from a practical point of view, since such connectors will tend to be damaged during sliding movement of the slidable window.

In view of the above, it will be apparent that there exists a need in the art for a slider window system for use in a pick-up truck or the like, where the window is resistant to fogging up on the inside thereof. Certain example embodiments of this invention relate to an improved slidable window for use in a pick-up truck or the like, with an interior surface that is resistant to fogging up. In certain example embodiments, the instant invention relates to a window structure that includes a pair of fixed window sheets and a slidable window sheet provided therebetween.

### SUMMARY OF EXAMPLE EMBODIMENTS OF INVENTION

Certain example embodiments of this invention relate to a window structure for use as a rear window in a pick-up truck or the like. In certain instances, the window structure may include a slidable window panel or sheet located between a pair of fixed window panels or sheets. The slidable window panel may be approximately flush with the fixed panels when in the closed position. However, when the slidable window panel is opened, it may be moved toward the vehicle interior slightly and then slid laterally to an open position(s) via one or more track(s). Thus, it will be appreciated that the movable window panel or sheet is not flush with the fixed panels when in an opened position.

In certain example embodiments of this invention, the interior surface of the slidable window is provided with a hydrophilic coating. The hydrophilic coating functions to prevent or reduce the tendency of the slidable window to fog up during certain environmental conditions.

In certain example embodiments of this invention, there is provided a method of making a window assembly, the method comprising forming a slidable window panel by using flame pyrolysis to (a) deposit a layer comprising silicon oxide on a glass substrate (directly or indirectly with other layer(s) therebetween) and/or (b) treat a layer comprising diamond-like carbon (DLC) to reduce its contact angle θ, thereby forming a hydrophilic layer having a contact angle θ of less than about 25 degrees; and locating the slidable window panel in operative relation with first and second fixed window panels, so that the slidable window panel is slidable relative to the first and second fixed window panels.

In other example embodiments, there is provided window assembly for a vehicle, the window assembly comprising first and second fixed window panels; a sliding window panel that is provided at least partially between the first and second fixed window panels when the sliding window panel is in a closed position; and wherein a hydrophilic coating is provided on an interior surface of the sliding window panel, wherein the hydrophilic coating has a contact angle θ of less than about 35 degrees.

In other example embodiments of this invention, there is provided a flush-closing multi-panel window assembly for a vehicle, the flush-closing multi-panel window assembly comprising first and second fixed window panels, a sliding window panel that is provided at least partially between the first and second fixed window panels when the sliding window panel is in a closed position, the sliding window being substantially flush with the first and second fixed window panels when in the closed position, and wherein a hydrophilic coating is provided on an interior surface of the sliding window panel, wherein the hydrophilic coating has a contact angle θ of less than about 35 degrees.

### BRIEF DESCRIPTION OF THE DRAWINGS

FIG. 1(a) is a perspective view of a rear window structure of a pick-up truck according to an example embodiment of this invention.

FIG. 1(b) is a cross sectional view of the slidable window of the structure of FIG. 1(a) according to an example embodiment of this invention.

FIG. 2 is a perspective view of the window structure of FIG. 1 in the closed position, as viewed from the interior of the vehicle, according to an example embodiment of this invention.

FIG. 3 is a close-up perspective view of a portion of the window structure of FIG. 2.

FIG. 4 is a cross sectional view of the window structure of FIG. 2 in the closed position, taken along section line 4-4 shown in FIG. 2.

FIG. 5 is a cross sectional view of the window structure of FIG. 2 in the closed position, taken along section line 5-5 shown in FIG. 2.

FIG. 6 is a cross sectional view of the window structure of FIG. 2 in the closed position, taken along section line 6-6 shown in FIG. 2.

FIG. 7 is a bottom plan view illustrating the top frame member, including the tracks therein, of the window structure of FIGS. 1-6 according to an example embodiment of this invention.

FIGS. 8(a)-8(b) are plan views of an example finger grip portion which may be used in the window structure of FIGS. 1-7; FIG. 8(a) is a side plan view and FIG. 8(b) is a front plan view.

FIGS. 9(a)-9(b) are plan views of an example selectively actuatable pin which may be used in the window structure of FIGS. 1-7; FIG. 9(a) is a front plan view and FIG. 9(b) is a side plan view.

FIG. 10 is a perspective view of a dual durometer interface (DDI) between an appliqué and a fixed glass sheet according to an example embodiment of this invention.

FIG. 11 is a cross sectional view of a bulb seal supported by a seal carrier that may be used in accordance with another embodiment of this invention.

FIG. 12 is a top plan view of the bulb seal of FIG. 11.

FIGS. 13(a)-13(c) are cross sectional views illustrating example steps for manufacturing the bulb seal of FIGS. 11-12 according to another example embodiment of this invention.

FIG. 14 is a side cross sectional partially schematic view illustrating a contact angle θ of a drop (e.g., sessile drop of water) on an uncoated glass substrate.

FIG. 15 is a side cross sectional partially schematic view illustrating a high contact angle θ of a drop on a coated article including a hydrophobic coating.

FIG. 16 is a side cross sectional partially schematic view illustrating a low contact angle θ of a drop (e.g., sessile drop of water) on a coated article according to an example embodiment of this invention with a hydrophilic coating.

### DETAILED DESCRIPTION OF EXAMPLE EMBODIMENTS OF INVENTION

Referring now more particularly to the accompanying drawings in which like reference numerals indicate like parts throughout the several views.

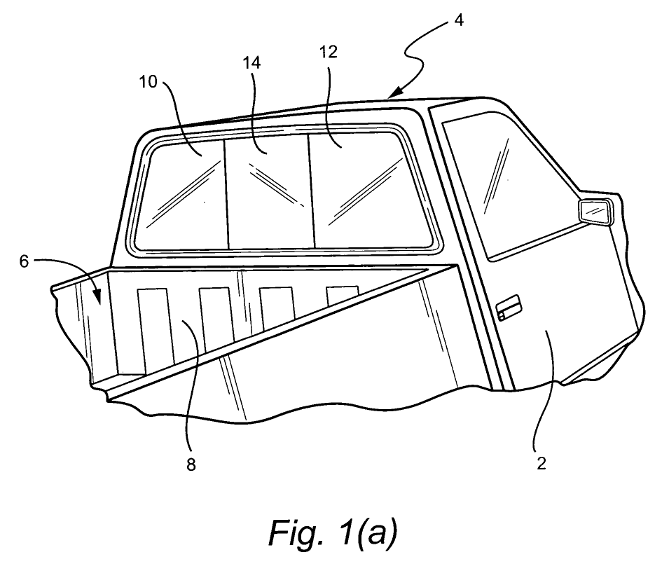

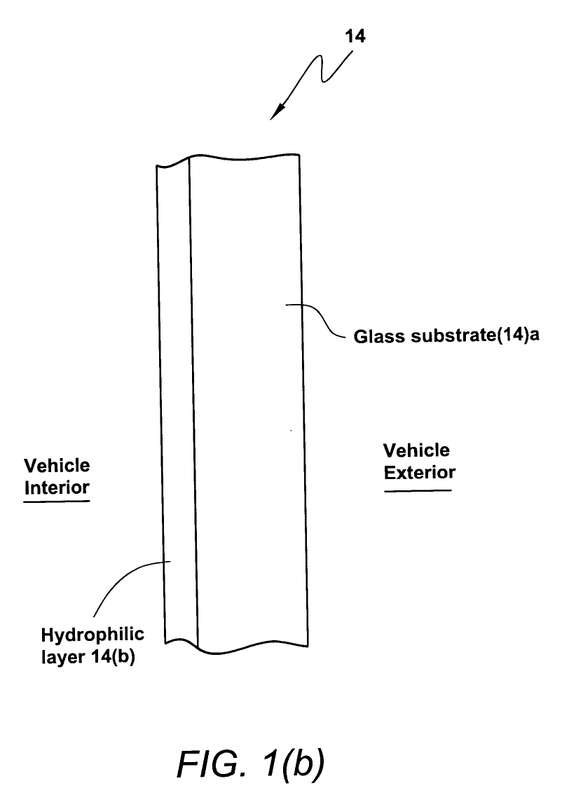

FIG. 1 is a view of a rear window structure of a pick-up truck according to an example embodiment of this invention. The pick-up truck includes front door 2, cab roof 4, and truck bed 6 at least partially defined by front bed wall 8. The window structure includes first and second fixed panels or sheets 10 and 12, and slidable/movable panel, sheet or window 14, all of which may be of or include glass, plastic, or the like. Each of panels or windows 10, 12 and 14 may be substantially transparent for window viewing purposes according to certain example embodiments of this invention, and each may be entirely flat or slightly curved/bent in shape according to certain example embodiments of this invention.

FIG. 1(b) illustrates that the slidable window or panel 14 comprises a glass substrate 14a which supports a hydrophilic coating 14b on the interior surface thereof facing the interior of the vehicle. The hydrophilic coating 14b may be made up of one or more layers. The hydrophilic coating 14b is advantageous in that it functions in an anti-fogging manner so as to prevent or reduce fogging up of the interior surface of the slidable window 14. This is significant because the sliding nature of this window 14 dictates that anti-fog grids and bus bars cannot be provided on the interior major surface of this window 14 from a practical point of view. While this anti-fog hydrophilic coating 14b is provided on and across the major interior surface of slidable window 14 in FIG. 1(b), the hydrophilic coating 14b may also be provided on and across the major interior surfaces of fixed windows 10 and 12 in certain example embodiments of this invention.

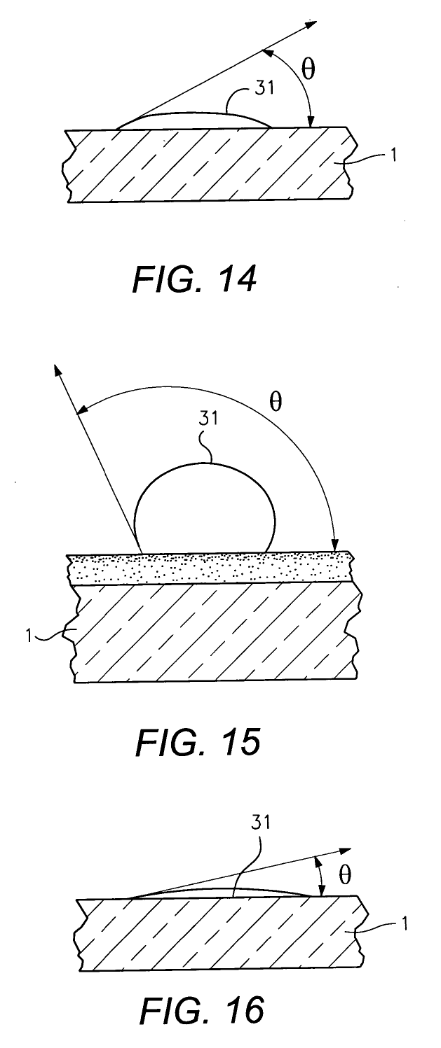

Hydrophilic performance of coating 14b is a function of contact angle θ, surface energy Υ, and/or wettability or adhesion energy W. The surface energy Υ of layer 14b may be calculated by measuring its contact angle θ. Exemplary contact angles θ are illustrated in FIGS. 14-16. A hydrophilic coating or layer system 14b according to an embodiment of this invention is on the substrate of FIG. 16 (i.e., low contact angle θ), while no coating of any kind is on the substrate of FIG. 14 and a hydrophobic coating (high contact angle) is on the substrate of FIG. 15. No coatings are illustrated in FIGS. 14 and 16 for purposes of simplicity. To measure contact angle θ in an example embodiment, a sessile drop 31 of a liquid such as water is placed on the substrate (which may be coated) as shown in FIGS. 14-16. A contact angle θ between the drop 31 and underlying article appears, defining an angle θ depending upon the interface tension between the three phases at the point of contact. The contact angle θ is greater in FIG. 15 than in FIG. 14, because the coating layer on the substrate in FIG. 15 is hydrophobic (i.e., results in a higher contact angle). However, in certain embodiments of this invention, the contact angle θ in FIG. 16 is low thereby indicating a hydrophilic nature of the layer 14b on the substrate.

Hydrophilic layer 14b may be made of materials such as silicon oxide (e.g., SiO₂) and/or diamond-like carbon (DLC) in different embodiments of this invention. In certain example embodiments, the hydrophilic nature (i.e., low contact angle) of the layer 14b is due to the flame pyrolysis treatment, ion beam treatment and/or hot water treatment of a DLC inclusive layer 14b that is on the substrate 1, and/or may be due to a flame pyrolysis deposition of a silicon oxide layer as a layer of coating 14b.

Generally, the surface energy Υ_{c} of a layer 14b or any other article/layer can be determined by the addition of a polar and a dispersive component, as follows: Υ_{c}=Υ_{CP}+Υ_{CD}, where Υ_{CP} is the layer's/coating's polar component and Υ_{CD} the layer's/coating's dispersive component. The polar component of the surface energy represents the interactions of the surface mainly based on dipoles, while the dispersive component represents, for example, van der Waals forces, based upon electronic interactions. Generally speaking, the higher the surface energy Υ_{c} of layer 3, the more hydrophilic the layer (and coated article) and the lower the contact angle. Adhesion energy (or wettability) W can be understood as an interaction between polar with polar, and dispersive with dispersive forces, between the exterior surface 9 of the coated article and a liquid thereon such as water. For a detailed explanation, see U.S. Pat. No. 6,713,179 (incorporated herein by reference). In certain example embodiments of this invention, the surface energy Υ_{C} of hydrophilic layer 14b may be at least about 20 mN/m, more preferably at least about 24 mN/m, and most preferably at least about 26 mN/m.

Moreover, a hydrophilic coating 14b according to any embodiment herein may be characterized by a low contact angle (θ). In certain example embodiments of this invention, hydrophilic layer or coating 14b has a contact angle θ less than about 35 degrees, more preferably less than about 25 degrees, more preferably less than about 20 degrees, even more preferably less than about 15 degrees, and sometimes even less than about 10 degrees. This low contact angle may be an initial contact angle when the layer is formed, and/or may occur after formation of the layer. Moreover, the low contact angle θ may be permanent or temporary.

An example hydrophilic coating 14b includes an outer layer (which may be the only layer of the coating, or alternatively may be the outermost layer of a multilayer coating) of silicon oxide (e.g., SiO₂) deposited by flame pyrolysis. Such a layer may be deposited for example, by introducing a gas such as a silane (e.g., TEOS) into at least one burner in order to cause a layer of silicon oxide to be deposited via combustion CVD on the substrate (e.g., glass or plastic substrate). Examples of flame pyrolysis are disclosed in, for example and without limitation, U.S. Pat. Nos. 3,883,336, 4,600,390, 4,620,988, 5,652,021, 5,958,361, and 6,387,346, the disclosures of all of which are hereby incorporated herein by reference.

Alternatively, the hydrophilic coating may be of or include diamond-like carbon (DLC) in certain example embodiments of this invention. For instances, any of the hydrophilic coatings of any of U.S. Patent Document Nos. 2004/0224161, 2004/0067363, 2004/0067368, 2004/0067362, U.S. Pat. Nos. 6,793,979, 6,713,179, 6,592,992, 6,303,225, or Ser. No. 10/967,342 (all of which are hereby incorporated herein by reference) may be used as hydrophilic layer 14b in certain example embodiments of this invention. In certain example instances, the hydrophilic layer 14b may comprise hydrogenated amorphous DLC, and may be highly tetrahedral in certain example embodiments.

In certain example embodiments, the contact angle θ in a coating 14b of a layer of or including DLC can be decreased by one or more of: (a) subjecting the DLC inclusive layer to flame pyrolysis treatment after it has been deposited by ion beam deposition or the like; (b) ion beam treating the DLC layer after it has been deposited, and/or (b) hot liquid/vapor treating the DLC layer after it has been deposited. In the flame pyrolysis treatment, one or more burners may be used. It has been found that the flame pyrolysis treatment and the ion beam treatment each increase the polar component of the DLC inclusive layer's surface energy, which in turn increases the layer's total surface energy. The higher the surface energy, the more hydrophilic the layer and the lower the contact angle θ. Thus, by increasing the surface energy via the flame pyrolysis treatment and/or ion beam treatment, the hydrophilicity of DLC can be improved and thus the contact angle θ lowered. In certain example embodiments, it has been found that subjecting the DLC inclusive layer to flame pyrolysis treatment and/or ion beam treating a DLC inclusive layer (e.g., using oxygen and nitrogen gases, and/or water vapor gas, for example, in the ion source(s)) causes the surface of the DLC inclusive layer to at least partially oxidize thereby causing its contact angle θ to quickly drop in a short period of time. In certain example embodiments, the flame pyrolysis treatment of the DLC inclusive layer causes the contact angle θ of the DLC inclusive layer to drop (decrease) at least about 5%, more preferably at least about 10%, still more preferably at least about 20%, even more preferably at least about 40%, still more preferably at least about 50%, and sometimes even at least about 60%. In other example embodiments, flame pyrolysis may be used to deposit a thin silicon oxide layer on a DLC layer to make up hydrophilic coating 14b.

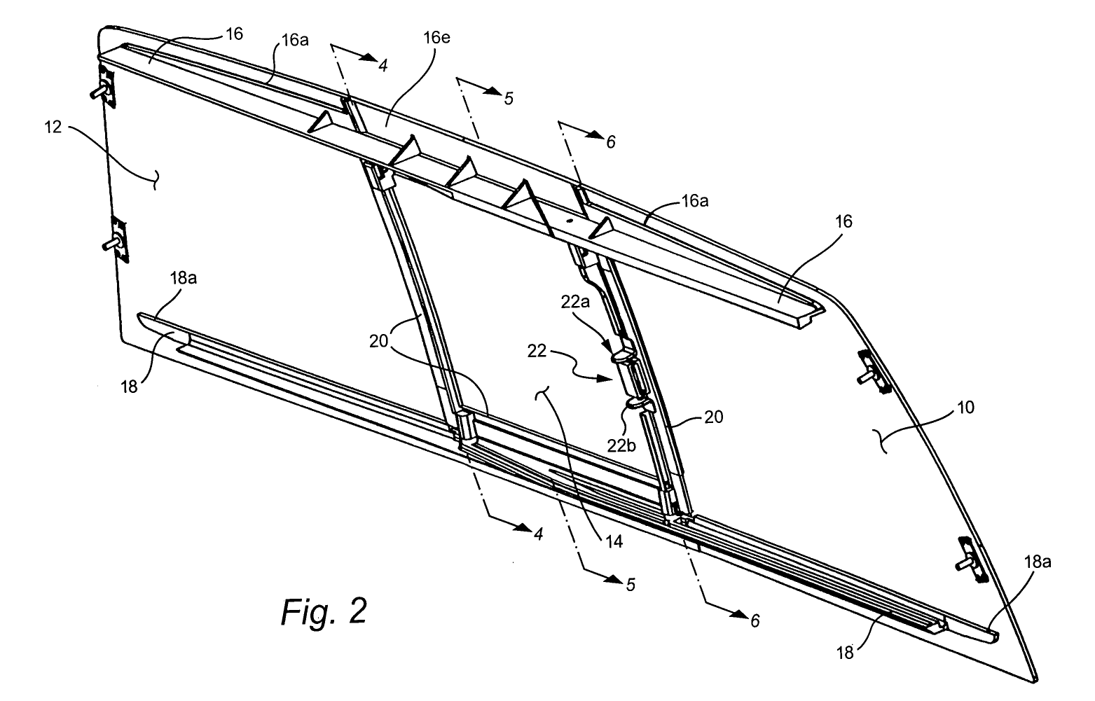

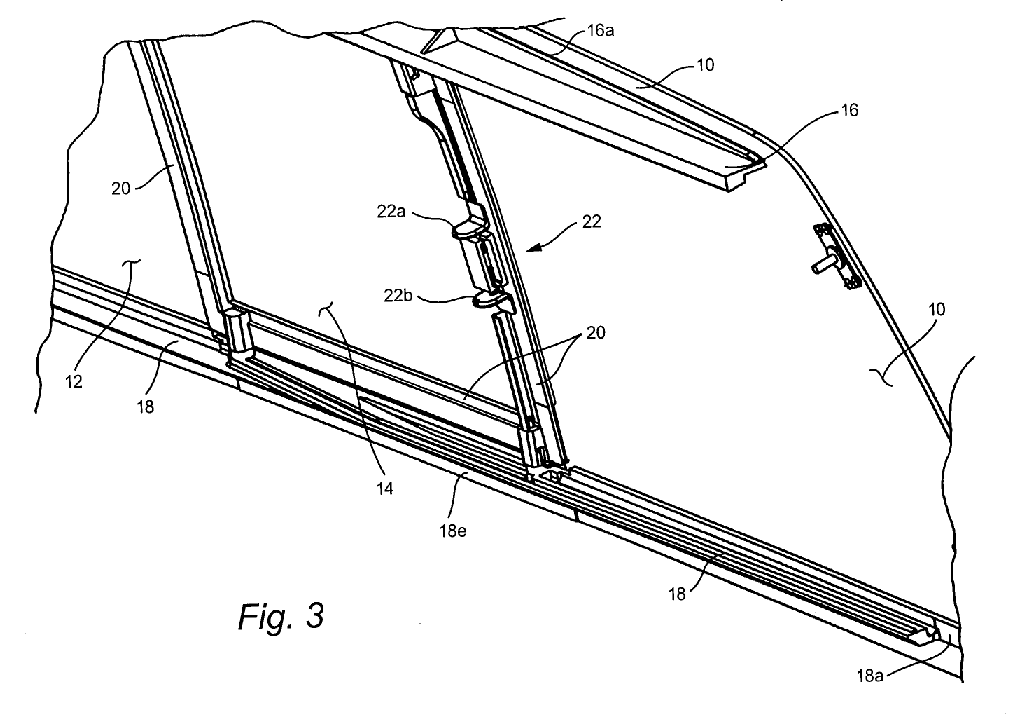

FIG. 2 is a detailed perspective view of the window structure of FIG. 1, as viewed from the interior of the truck cab, and FIG. 3 is an enlarged perspective view of certain aspects of FIG. 2. FIGS. 2-3 illustrate the slidable/movable window panel or sheet 14 in the closed position, between the fixed window panels 10 and 12, wherein the movable panel 14 is flush or substantially flush with the fixed panels 10, 12. The window structure includes top frame 16, bottom frame 18, seal carrier 20 which is attached around at least part of the periphery of movable panel 14, and latch assembly 22 which is used to allow slidable window panel 14 to be moved from a closed position to an opened position. The latch assembly 22 also locks the panel 14 in the closed position when this is desired. Fixed panels 10 and 12 are approximately the same size in certain example embodiments of this invention, whereas movable panel 14 may have a height smaller than that of panels 10, 12 in certain example embodiments of this instant invention.

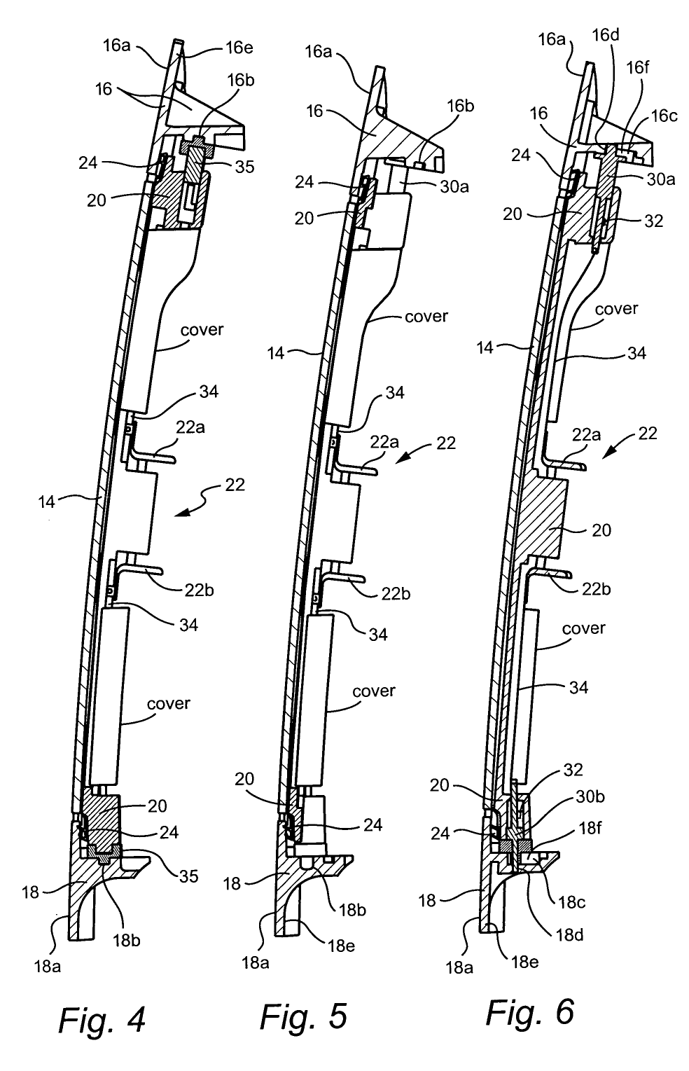

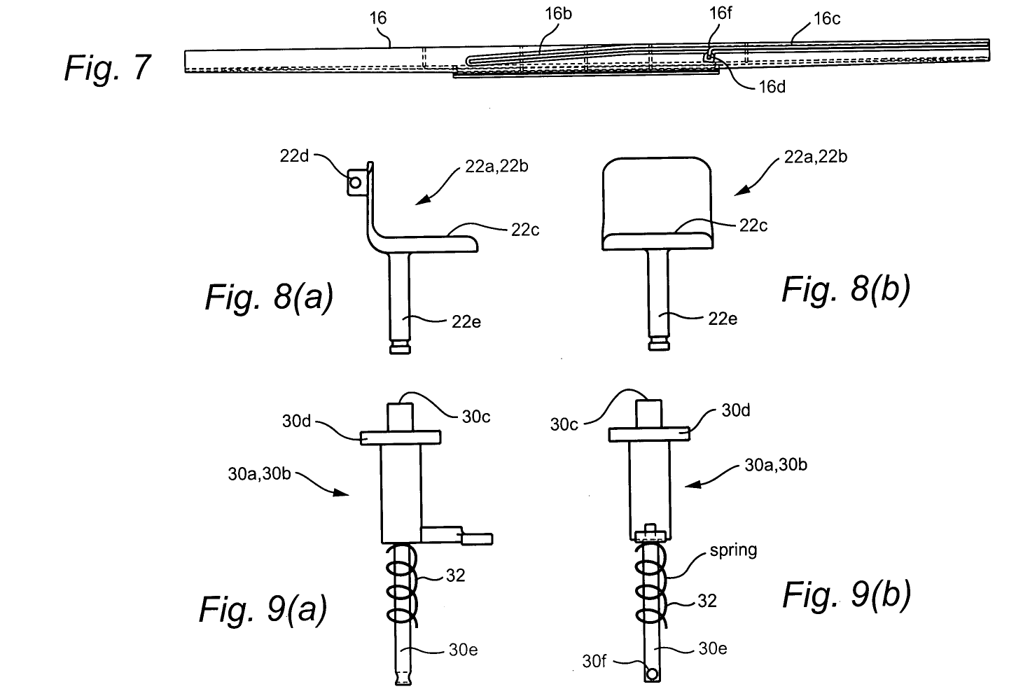

FIGS. 4, 5 and 6 are cross sectional views of the window structure of FIGS. 2-3, taken along section lines 4-4, 5-5, and 6-6, respectively, shown in FIG. 2. Thus, FIGS. 4-6 illustrate the top frame 16, bottom frame 18, seal carrier 20 and latch assembly 22 in respective positions when the slidable panel 14 is in the closed position flush with the other panels 10, 12. FIG. 7 is a bottom plan view of the top frame 16, illustrating the tracks therein in which pins operative associated with the movable panel 14 slide during opening and closing of the movable panel 14 (the bottom frame 18 includes similar tracks).

Referring especially to FIGS. 2-7, the window structure according to an example embodiment of this invention will be described in more detail. Each of the top and bottom frames 16 and 18, respectively, include a substantially planar (planar or slightly curved) back portion 16a, 18a that is attached to a major surface of the fixed window panels 10 and 12 (but not to the movable panel 14). In other words, the substantially planar back portion 16a of top frame 16 is bonded to the major interior surface of each of fixed panel 10 and fixed panel 12 at a top portion of each panel via an adhesive or the like. Likewise, the substantially planar back portion 18a of bottom frame 18 is bonded to the major interior surface of each of fixed panel 10 and fixed panel 12 at a bottom portion of each panel via an adhesive or the like. Moreover, each of the top and bottom frames 16, 18 includes first and second tracks (16b, 16c, 18b, 18c) defined therein (to be described more fully below) which receive pins operatively associated with the latch assembly. Thus, it can be seen that both the top and bottom frames 16 and 18 function both as supports for fixed window panels 10 and 12, and also as track defining members which include tracks 16b, 16c, 18b, 18c that allow the slidable panel 14 to open and close in a sliding manner. The top and bottom frames 16 and 18 may be attached to the panels 10 and 12 in any suitable manner, including but not limited to via urethane adhesive, UV curable adhesive, encapsulation, double sided tape, or the like.

In certain embodiments of this invention, the movable panel 14 is smaller in height than the fixed panels 10, 12. Thus, in order to cover up voids arising from the smaller size of the movable panel 14, one or both frames may include filler or cover portions 16e, 18e (which may be referred to as appliqués in certain instances) which cover such voids. Appliques 16e and/or 18e may or may not be integrally formed with the frames 16, 18 in different embodiments of this invention. For example, appliqués 16e and 18e may be bonded to tracks or frames 16 and 18, respectively, in certain example embodiments of this invention so that the frames/tracks support the appliqués. Frames 16 and 18 may be formed of injection molded plastic, metal or any other suitable material in different embodiments of this invention. Appliques 16e, 18e are preferably of polymer based plastic material in certain example embodiments of this invention.

It can be seen best in FIGS. 4-6 that the top and bottom frames 16 and 18 are not attached to the central movable window panel 14. These frames 16, 18 are only attached to the fixed panels 10, 12 via adhesive or the like as explained above. As best shown in FIGS. 2-6 seal carrier 20 (but not frames 16, 18) is attached to the peripheral portion of movable window panel 14 via adhesive or the like. Thus, seal carrier 20 (but not frames 16, 18) moves/slides along with panel 14 when the panel is moved from the closed position to the opened position and vice versa. In certain example embodiments of this invention, as shown in FIGS. 2-6, seal carrier 20 is attached to panel 14 around all four peripheral sides thereof at or close to the edge of the panel. Moreover, a seal (e.g., bulb seal, finger seal, or the like) 24 is provided on the seal carrier 20 at a location where the seal carrier 20 and frames 16, 18 are immediately adjacent one another. Seal 24 functions to provide a weather seal between the movable seal carrier 20 and the fixed frames 16, 18. Flexible seal 24 may be of rubber or other polymer based material in certain example embodiments of this invention.

Dual pull latch assembly 22 is mounted on and/or supported by seal carrier 20. The latch assembly 22 includes first and second finger grip portions 22a, 22b which are adapted to be selectively squeezed together by a user, first and second spring loaded pin structures 30a, 30b operatively associated with the finger grip portions, biasing springs 32 which surround elongated portions of the pin structures as best shown in FIG. 9, and cables 34 which extend between and interconnect the finger grip portions 22a, 22b and the pin structures 30a, 30b. Biasing springs 32 exert a biasing force which biases the pin structures 30a, 30b away from one another and into respective apertures or cut-outs 16d, 18d defined in the frames as best shown in FIG. 6 (the pin structures are in such as position when the panel 14 is in the closed position). In certain example embodiments of this invention, the spring loaded pins 32 are contained at least partially in the seal carrier 20 which is bonded to the center sliding glass sheet or panel 14.

When a user squeezes the finger grip portions 22a and 22b toward one another with his/her fingers, this causes the respective cables 34 to also move toward one another thereby pulling the pin structures 30a and 30b toward one another and out of apertures/cut-outs 16d and 18d, respectively, against the biasing force of springs 32. In certain other embodiments of this invention, cable(s) 34 may be replaced with elongated rods or other similar type component(s). When the spring loaded pin structures have been pulled from apertures/cut-outs 16d and 18d, respectively, then the panel 14 may be kicked or will pop inwardly toward the vehicle interior and then slid laterally in order to open the window as will be more fully described below.

In other example embodiments of this invention, the user need not actually touch members 22a, 22b in order to actuate the latch assembly 22. For example, another selectively actuatable mechanism (mechanical and/or electric) could be provided for causing members 22a, 22b or similar members to be moved toward one another in order to move the pins 30a, 30b from the locked position to the unlocked position. For example, a single flip or T-shaped handle lever cold be used to simultaneously move spring loaded pins 30a, 30b toward one another in order to move the pins from the locked position to the unlocked position to that the panel 14 could be opened.

As shown in FIGS. 2-3 and 6, latch assembly 22 is only provided on one side of the movable panel 14. Fixed pins 35 are attached to the other side of the movable panel (i.e., to the trailing side of panel 14 during opening) via seal carrier 20 as best shown in FIG. 4. Fixed pins 35 typically slide in tracks of the frames 16, 18, but are not movable relative to the seal carrier 20 and/or panel 14.

As example process for opening and closing with window will now be described with reference to FIGS. 2-9. This example process is provided for purposes of example only. FIGS. 2-6 illustrate the panel 14 in the closed position. In this position, the panel 14 is approximately and sometimes perfectly flush with fixed panels 10, 12. In the closed position shown in FIGS. 2-6, the movable panel 14 is flush with both the rear surfaces 16a, 18a of the frame portions immediately adjacent thereto, and also with the fixed panels 10, 12.

In the closed position, the biasing force of springs 32 presses pins 30 into respective apertures/cut-outs 16d, 18d defined in the frames 16, 18 thereby holding the panel 14 in place between the fixed panels 10, 12. When a user desires to open the window (i.e., move panel 14 into an opened position), the user from the vehicle interior squeezes finger grip portions 22a and 22b toward one another against the biasing force of springs 32. When finger grip portions 22a and 22b are moved toward one another, this in turn causes respective cables 34 and pins 30 to be moved toward one another, thereby causing ends of the pins 30 to be removed from apertures/cut-outs 16d, 18d defined in the frames 16, 18.

Once the ends of the pins 30 have been removed from the apertures/cut-outs 16d, 18d defined in the frames 16, 18, the movable panel 14 is shifted (or kicked-in) toward the vehicle interior. The force which causes at least one side of the panel 14 to be shifted toward the vehicle interior may be caused by biasing force generated by seals 24 against the frames 16, 18 and/or by pulling force on the latch assembly 22 generated by the user. In any event, when the panel 14 is shifted or kicked-in toward the vehicle interior, fixed pins 35 at one side of the panel substantially remain in place; but actuatable pins 30 at the latch side of the panel slide in guide channels 16f, 18f defined in the respective frames 16, 18 from apertures/cut-outs 16d, 18d toward the vehicle interior. Guide channels 16f, 18f are in communication with tracks 16c, 18c, respectively, and are generally oriented in a direction from about 45 to 90 degrees angled relative to tracks 16c, 18c. The upper and lower pins 30 slide in guide channels 16f, 18f, respectively, away from apertures/cut-outs 16d, 18d and into main tracks 16c, 18c defined in the frames.

After the upper and lower pins 30 have moved into main tracks 16c, 18c, the user slides the panel 14 laterally in order to open the same. As the panel 14 slides laterally, actuatable pins 30 slide in main tracks 16c, 18c and fixed pins 35 slide in tracks 16b, 18b. Eventually, tracks 16b and 18b may merge into main tracks 16c and 18c, respectively, as shown in FIG. 7 for example, so that the leading pins 30 and trailing pins 35 may travel in the same tracks. The panel 14 is thus opened in such a manner. In the opened position, the panel 14 is not flush with fixed panels 10, 12.

When it is desired to close the window, the user slides panel 14 back toward the opening defined between the fixed panels. As the panel is slid laterally toward the closed position, pins 35 will eventually make their way into tracks 16b, 18b, whereas pins 30 slide in tracks 16c, 18c. After the panel 14 has been slid to a position immediately adjacent the opening defined between the fixed panels, the panel 14 is pushed by the user away from the vehicle interior toward the truck bed so that pins 30 slide out of tracks 16c, 18c and through guide channels 16e, 18e against the biasing force of seals 24. When the panel 14 is pushed/pressed far enough in this direction, the ends of pins 30 finally are located over apertures/cut-outs 16d, 18d and the biasing force of springs 32 causes the ends of pins 30 to move into the apertures/cut-outs 16d, 18d thereby locking the panel 14 in the closed position.

FIGS. 8(a)-8(b) illustrate an example finger grip portion 22a (or 22b) which may be used in certain example embodiments of this invention. As can be seen, each grip portion 22a (or 22b) includes an approximately L-shaped portion. The finger grip portions includes an area 22c adapted to be pressed by a finger(s) of the use, a connection aperture 22d used for allowing the cable 34 to be connected to the finger grip portion, and an elongated structure or retaining shaft 22e adapted to be received in a corresponding aperture(s) defined in the seal carrier 20. In other example embodiments of this invention, finger grip portions 22a, 22b may be replaced with finger rings or any other suitable structure attached to cable(s) 34. Also, other shaped finger grip portions may be used in certain embodiments of this invention.

FIGS. 9(a)-9(b) illustrate an example pin structure 30 according to an example embodiment of this invention. The pin or pin structure 30 includes an end 30c adapted to slide in guide channels 16e, 18e and tracks 16c, 18c, and be received in apertures/cut-outs 16d, 18d. The pin or pin structure 30 also includes a first flange portion 30d, a shaft 30e with spring 32 provided around the same, and a connection aperture 30f defined proximate an end of shaft 30e. Such a pin shape is provided for example only, and is not intended to be limiting unless expressly claimed as with all other detailed disclosed herein.

Seal 24 is supported by the seal carrier 20 so as to provide a weather seal between the movable seal carrier 20 and the fixed frames 16, 18 and top and bottom portions of the movable panel 14. However, in certain example embodiments of this invention, seal 24 may be four-sided so as to be located around the entire periphery of movable panel 14. For example, FIGS. 11-12 illustrate such a four-sided seal 24″ that is to be supported by the seal carrier 20 for sealing proximate all four sides of the movable panel 14.

While the seal 24 (or 24″) may be formed by any suitable technique, in certain example preferred embodiments of this invention the seal is formed by injection molding as a hollow flexible seal member (i.e., bulb seal) to extend proximate the entire periphery of movable panel 14 and to be supported by seal carrier 20. Moreover, in certain example embodiments of this invention, this injection molded bulb seal 24 (or 24″) is located so as to fill or cover the gap(s) between the movable panel 14 and the adjacent panel (10 and/or 12) as shown in FIG. 11. This allows the seal to form a water seal to prevent water from the exterior of the vehicle from making its way through the gap(s) between the movable panel 14 and the adjacent panel (10 and/or 12) as shown in FIG. 11.

This injection molded one-piece bulb seal 24″ (e.g., supported by the seal carrier 20) is advantageous with respect to other seal types. For example, by filling or covering the gaps between the fixed and movable panels, the seal can prevent water from making its way into the vehicle interior through such gaps. Moreover, by forming this seal by injection molding into a one-piece type bulb seal, a better seal can be provided. Since injection molding is used to form the seal 24″ in a one-piece manner, weld corners that can be present with other manufacturing techniques can be eliminated (weld corners are a weak point and can lead to leakage). Moreover, the use of injection molding to form a one-piece seal 24″ allows the cross section of the seal 24″ to be varied. For example, as shown in FIG. 12, the seal 24″ can have a larger surface area at corner areas to provided adding sealing functionality at such areas. This is advantageous in that corner areas are typical seal failure points, and this technique allows for improved sealing at such areas. Seal carrier 20 may be made of or comprise polycarbonate (PC), polypropylene (PP), or any other suitable polymer based material in different embodiments of this invention.

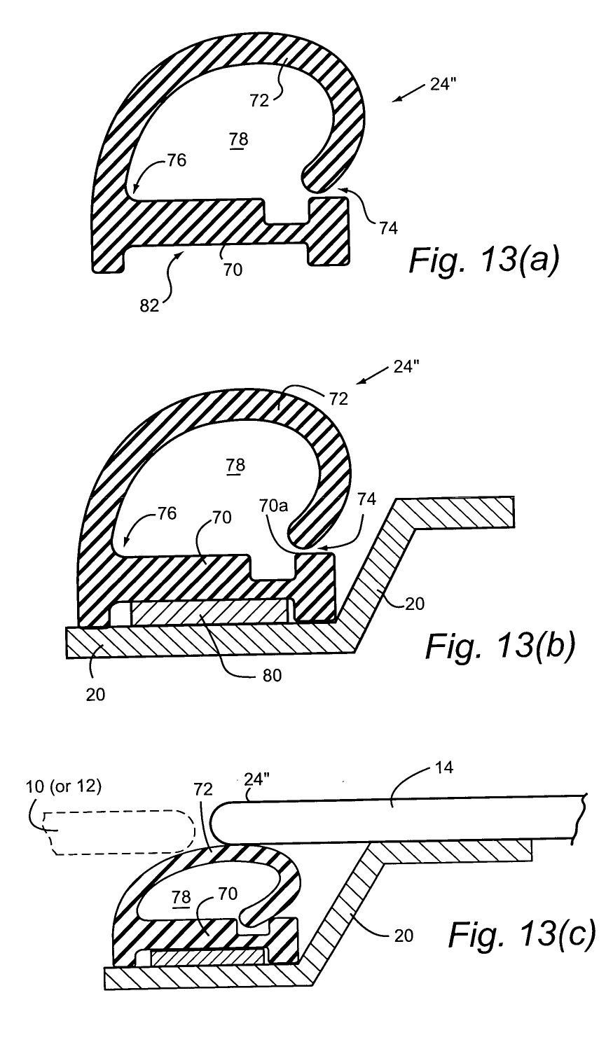

FIGS. 13(a)-13(c) illustrate an example technique for making bulb seal 24″ according to an example embodiment of this invention. As previously discussed, this bulb seal 24″ may be used in the manner shown in FIGS. 11-12. FIG. 13(a) is a cross section of the bulb seal 24″ as formed by injection molding upon removal from the mold. The bulb seal 24″ includes base 70 and curved flexible bulb or lip portion 72 which extends therefrom. The bulb or lip portion 72 includes two ends, the first end 74 being a distal end which is located proximate to but not physically connected to a top portion 70a of the base 70 so that a gap is provided therebetween when the lip portion 72 is in a relaxed unbiased state. The second end 76 of the bulb or lip portion is integrally formed with and attached to another end or side of base 70, so that a hollow cavity 78 is formed between the inner periphery of the lip or bulb portion 72 and the top surface of the base 70.

The bottom surface of the base 70 is attached to the seal carrier 20 via double-sided adhesive tape or any other suitable adhesive 80 as shown in FIG. 13(b). In the illustrated embodiment, the tape/adhesive 80 is located in a recess 82 formed in the bottom surface of the base 70 as shown in FIGS. 13(a)-(b). In certain example embodiments of this invention, flexible bulb seal material for seal 24″ may be made of or comprise an elastomer or compression set material (e.g., EPDM). This flexible bulb seal 24″ may be four-sided as shown in FIG. 12 so as to extend around the entire periphery of movable panel 14. In such four-sided bulb seal 24″ embodiments, the bulb seal 24″ thus seals the gaps between the movable panel 14 and the fixed panels 10, 12, and may also seal the gaps between the movable panel 14 and the appliqués 16e, 18e and/or frames 16, 18. It can be seen in FIG. 12 that no welded corners or weld joints (which would be present if extrusion was used) are located at the four corner areas of the bulb seal 24″, since the flexible bulb-portion of seal 24″ (which does not include carrier 20) is injection molded so as to be continuously formed of one piece to extend around the entire periphery of the movable panel 14 (e.g., see panel 14 in FIG. 14).

FIG. 13(c) illustrates the bulb seal 24″, supported by seal carrier 20, sealing the gap between movable panel 14 and the fixed panel(s) 10 and/or 12. When the bulb seal 24″ is in sealing position, the lip or bulb portion 72 seals the gap between panel 14 and panel(s) 10/12, and the edges of the panel(s) bias the bulb or lip portion 72 toward the base 70 so that end 74 of the portion 72 contacts the base 70. Biasing of the bulb seal can work as discussed above, wherein the bulb seal 24″ provides a biasing force against at least one of the upper and lower frame members so as to cause at least part of the sliding window panel to move toward an interior of the vehicle when the first and second selectively actuatable members or any other suitable member(s) are moved toward one another.

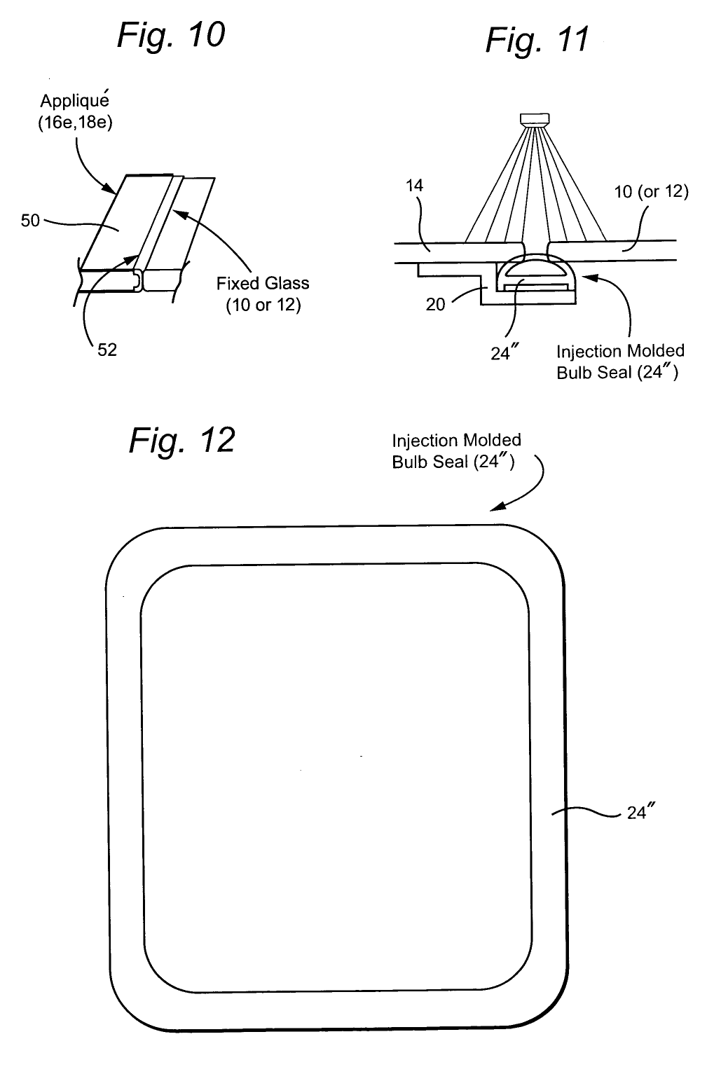

FIG. 10 is a close-up perspective view of a DDI interface according to an example embodiment of this invention. Fixed glass panel (10, 12) is located immediately adjacent to appliqué (16e, 18e), in an abutting fashion. It can be seen in FIG. 10 for example that an edge of a fixed panel (10 or 12) abuts an edge of the adjacent appliqué (16e or 18e). The appliqué (16e or 18e) includes both a polymer-based main body portion 50 and a softer more flexible edge portion 52, both of which are preferably of polymer based materials. In certain example embodiments of this invention, the edge abutting portion 52 is made of a softer and more flexible polymer based material than is main body portion 50 of the appliqué. Thus, the softer edge portion 52 of the appliqué is the portion of the appliqué which comes into abutting sealing contact with the fixed panel (10 or 12) as shown in FIG. 10. It has been found that the use of such a DDI interface between the appliqué and fixed panel(s) allows for a better weather seal to be formed therebetween so that leakage can be reduced. The dual durometer portions (i.e., plastic portions 50 and 52 of different hardnesses) can be made in any suitable fashion, such as via a two shot mold design.

The abutting portion 52 of softer material may be formed around the entire periphery of the appliqué in certain example embodiments of this invention, or alternatively may be located on one, two or three sides thereof in other embodiments. For example, in certain example embodiments, the abutting portion 52 of softer material may be located only at first and second opposite edges of the appliqué, in a spaced apart manner, so as to abut respective edges of first and second fixed window panels 10 and 12.

In certain example embodiments of this invention, the harder main body portion 50 of the appliqué may be made of a relatively hard polymer based material such as ASA, whereas the softer edge portion 52 of the appliqué may be made of a softer polymer based material such as EPDM. The material of portion 52 is much more compressible and flexible than the material of portion 50, so as to allow for improved sealing and manufacturing variation/tolerance.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A flush-closing multi-panel window assembly for a vehicle, the flush-closing multi-panel window assembly comprising:
first and second fixed window panels;
a sliding window panel that is provided at least partially between the first and second fixed window panels when the sliding window panel is in a closed position, the sliding window being substantially flush with the first and second fixed window panels when in the closed position; and
wherein a hydrophilic coating is provided on an interior surface of the sliding window panel, wherein the hydrophilic coating has a contact angle θ of less than about 35 degrees.

2. The flush-closing multi-panel window assembly of claim 1, wherein the hydrophilic coating has a contact angle θ of less than about 25 degrees.

3. The flush-closing multi-panel window assembly of claim 1, wherein the hydrophilic coating has a contact angle θ of less than about 20 degrees.

4. The flush-closing multi-panel window assembly of claim 1, wherein the hydrophilic coating has a contact angle θ of less than about 15 degrees.

5. The flush-closing multi-panel window assembly of claim 1, wherein the hydrophilic coating has a contact angle θ of less than about 10 degrees.

6. The flush-closing multi-panel window assembly of claim 1, wherein the hydrophilic coating comprises a layer comprising silicon oxide form via flame pyrolysis.

7. The flush-closing multi-panel window assembly of claim 1, wherein the hydrophilic coating comprises a layer comprising silicon oxide located over at least a layer comprising diamond-like carbon (DLC).

8. The flush-closing multi-panel window assembly of claim 1, wherein the sliding window panel

9. The flush-closing multi-panel window assembly of claim 1, wherein the sliding window panel comprises a glass substrate that supports the hydrophilic coating.

10. The flush-closing multi-panel window assembly of claim 1, wherein the hydrophilic coating is provided on interior major surfaces of each of the fixed window panels.

12. The flush-closing multi-panel window assembly of claim 1, further comprising a seal carrier supported by the sliding window panel; and an injection molded bulb seal supported by at least the seal carrier, wherein the injection molded bulb seal extends around an entire periphery of the sliding window panel so as to cover gap(s) adjacent the edge of the sliding window panel.

13. The flush-closing multi-panel window assembly of claim 12, further comprising:
an upper frame member and a lower frame member, each of the upper and lower frame members being attached to the first and second fixed window panels; and wherein each of the upper and lower frame members includes a track defined therein to allow for sliding of the sliding window panel;
a latch assembly including first and second spring biased pins adapted to slide in tracks of the upper and lower frame members, respectively, during opening and closing of the sliding window panel; and
wherein the latch assembly further includes first and second selectively actuatable members adapted to be moved toward one another so that when the first and second selectively actuatable members are moved toward one another the first and second pins are caused to exit first and second apertures and/or cut-outs defined in the upper and lower frame members, respectively, and the sliding window panel can thereafter be slid laterally in order to open the sliding window panel.

14. The flush-closing multi-panel window assembly of claim 13, wherein the bulb seal provides a biasing force against at least one of the upper and lower frame members.

15. The flush-closing multi-panel window assembly of claim 13, wherein the bulb seal provides a biasing force against at least one of the upper and lower frame members so as to cause at least part of the sliding window panel to move toward an interior of the vehicle when the first and second selectively actuatable members are moved toward one another and the first and second pins are caused to exit first and second apertures and/or cut-outs.

16. The flush-closing multi-panel window assembly of claim 13, wherein the first and second pins are at least partially located in respective apertures defined in the seal carrier.

17. A window assembly for a vehicle, comprising:
first and second fixed window panels;
a sliding window panel that is provided at least partially between the first and second fixed window panels when the sliding window panel is in a closed position; and
wherein a hydrophilic coating is provided on an interior surface of the sliding window panel, wherein the hydrophilic coating has a contact angle θ of less than about 35 degrees.

18. The window assembly of claim 17, wherein the hydrophilic coating has a contact angle θ of less than about 20 degrees.

19. The window assembly of claim 17, wherein the hydrophilic coating comprises a layer comprising silicon oxide and/or a layer comprising DLC.

20. A method of making a window assembly, the method comprising:
forming a slidable window panel by using flame pyrolysis to (a) deposit a layer comprising silicon oxide on a glass substrate and/or (b) treat a layer comprising diamond-like carbon (DLC), thereby forming a hydrophilic layer having a contact angle θ of less than about 25 degrees; and
locating the slidable window panel in operative relation with first and second fixed window panels, so that the slidable window panel is slidable relative to the first and second fixed window panels.

21. The method of claim 20, wherein a coating formed by the flame pyrolysis is located on an interior surface of the slidable window panel.

22. The method of claim 20, wherein the flame pyrolysis is used to deposit a layer comprising silicon oxide on a layer comprising DLC, wherein the DLC had previously been ion beam deposited.
